(19) United States
(12) Patent Application Publication
(10) Pub. No.: US 2009/0159647 A1
(43) Pub. Date: Jun. 25, 2009

(54) Method for bonding glassy metals

(75) Inventors: Shing-Hoa Wang, Keelung (TW); Pei-Hung Kuo, Keelung (TW); Peter K. Liaw, Knoxville, TN (US); Guo-Jiang Fan, Knoxville, TN (US); Hsiao-Tsung Tsang, Tao-Yuan (TW); Dongchun Qiao, Knoxville, TN (US); Feng Jiang, Knoxville, TN (US)

Correspondence Address: OHLANDT, GREELEY, RUGGIERO & PERLE, LLP, ONE LANDMARK SQUARE, 10TH FLOOR, STAMFORD, CT, 06901, US

(73) Assignee: NATIONAL TAIWAN OCEAN UNIVERSITY

(21) Appl. No.: 12/151,662

(22) Filed: May 8, 2008

(30) Foreign Application Priority Data
Dec. 20, 2007 (TW) 096148928

(51) Int. Cl. B23K 20/00

(52) U.S. Cl. 228/193

(57) ABSTRACT

A method for bonding two glassy metal pieces, includes: (a) disposing the glassy metal pieces in an environment such that the surrounding of the glassy metal pieces is heated to a working temperature within a common supercooled liquid region of the glassy metal pieces; and (b) pressing one of the glassy metal pieces against the other of the glassy metal pieces under an elevated pressure while maintaining the working temperature for a suitable period of time so as to subject the glassy metal pieces to undergo solid state diffusion at an interface therebetween.

### CROSS-REFERENCE TO RELATED APPLICATION

This application claims priority of Taiwanese application no. 096148928, filed on Dec. 20, 2007.

### BACKGROUND OF THE INVENTION

1. Field of the Invention

This invention relates to a method for bonding two glassy metal pieces, more particularly to a method involving a solid state diffusion by heating a surrounding of the glassy metal pieces to a working temperature within a common supercooled liquid region of the glassy metal pieces.

2. Description of the Related Art

A glassy metal is an amorphous material that exhibits excellent properties, such as high strength, high hardness, high resistance to corrosion and high ferromagnetism.

A conventional method for bonding small-sized glassy metal pieces into a large unit includes friction welding techniques. Friction welding techniques involve a high speed rotating one of the glassy metal pieces relative to the other of the glassy metal pieces under a room temperature so as to generate frictional heat therebetween at an instantaneous time and so as to raise temperatures of contact ends of the glassy metal pieces to permit softening of the contact ends of the glassy metal pieces, and then bonding them together by applying an external pressure thereto. However, control of the temperatures at the contact ends of the glassy metal pieces is relatively difficult through friction. As a consequence, undesired crystallization is likely to occur during bonding of the glassy metal pieces, and a relatively high-pressure is required to be applied on the glassy metal pieces such that portions of the glassy metal pieces are squeezed to form flash at the joint therebetween, thereby pushing the undesired crystals to move into the flash, which is subsequently removed. In addition, the friction welding technique requires the glassy metal pieces to have a high glass forming ability and stable supercooled characteristics, and is not suitable for bonding glassy metals that have a higher fragility and the non-cylindrical shape pieces.

### SUMMARY OF THE INVENTION

Therefore, an object of the present invention is to provide a method for bonding two glassy metal pieces that can overcome the aforesaid drawbacks associated with the conventional method.

According to the present invention, a method for bonding two glassy metal pieces comprises: (a) disposing the glassy metal pieces in an environment such that the surrounding of the glassy metal pieces is heated to a working temperature within a common supercooled liquid region of the glassy metal pieces; and (b) pressing one of the glassy metal pieces against the other of the glassy metal pieces under an elevated pressure while maintaining the working temperature for a suitable period of time so as to subject the glassy metal pieces to undergo solid state diffusion at an interface therebetween.

### BRIEF DESCRIPTION OF THE DRAWINGS

Other features and advantages of the present invention will become apparent in the following detailed description of the preferred embodiment of this invention, with reference to the accompanying drawings, in which:

FIG. 1 is a Differential Scanning Calorimetry diagram of the two glassy metal pieces used in a method embodying the present invention;

FIG. 2 is an X-ray diffraction graph of an interface of the bonded glassy metal pieces for Example 1;

FIG. 3 is an X-ray diffraction graph of a base and an interface of the bonded glassy metal pieces for Examples 2 and 3;

FIG. 4a to 4c are an electron probe microanalyzer plots showing concentration distributions of each element of the bonded glassy metal pieces for Examples 1-3; and

FIG. 5 is a plot showing nano-indenter hardness/distance relation of the bonded glassy metal pieces for Examples 1-3.

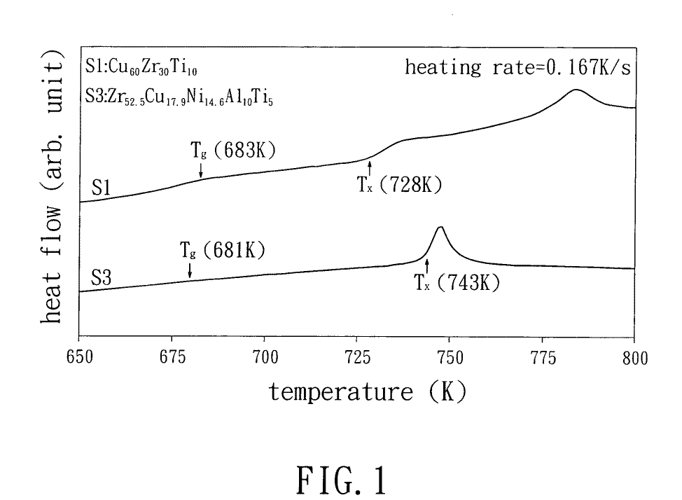

### DETAILED DESCRIPTION OF THE PREFERRED EMBODIMENT

The method for bonding two glassy metal pieces according to this invention includes: (a) disposing the glassy metal pieces in an environment such that the surrounding of the glassy metal pieces is heated to a working temperature within a common supercooled liquid region of the glassy metal pieces, which is a region of overlap between a temperature region from T_{g} (the glass transition temperature) to Tₓ (the crystallization temperature) of one of the glassy metal pieces and another temperature region from T_{g} to Tₓ of the other of the glassy metal pieces; and (b) pressing one of the glassy metal pieces against the other of the glassy metal pieces under an elevated pressure while maintaining the working temperature for a suitable period of time so as to subject the glassy metal pieces to undergo solid state diffusion at an interface therebetween.

Preferably, the elevated pressure in step (b) ranges from 12 MPa to 15 MPa.

Preferably, a strain rate of the glassy metal pieces is not greater than 10⁻⁵/sec.

In this embodiment, the glassy metal pieces in step (a) are disposed in a temperature-controllable oven.

In this embodiment, each of the glassy metal pieces is Zr—Cu based glassy metal.

Preferably, the Zr—Cu based glassy metal has a modified glass forming ability γₘ, which is equal to (2Tₓ−T_{g})/Tₗ, where Tₗ is melting point, (definition of the modified glass forming ability γₘ can be found in the publication by X. H. Du, J. C. Huang, C. T. Liu, and Z. P. Lu, J. Appl. Phys., 2007, 101, 086108) not less than 0.68 when the Zr—Cu based glassy metal is Cu₆₀Zr₃₀Ti₁₀, and not less than 0.74 when the Zr—Cu based glassy metal is Zr_{52.5}Cu_{17.9}Ni_{14.6}Al₁₀Ti₅.

Preferably, the common supercooled liquid region ranges from 10K to 20K.

Preferably, the environment in step (a) is under a vacuum not larger than 10⁻⁵ torr.

Preferably, the environment in step (a) is an inert gas environment.

The merits of the method of this invention will become apparent with reference to the following Examples.

### EXAMPLES

### Example 1

Two glassy metal pieces having different compositions of Cu₆₀Zr₃₀Ti (S1) and Zr_{52.5}Cu_{17.9}Ni_{14.6}Al₁₀Ti₅ (S3) with a diameter of 1.8 mm and a length ranging from 4 cm to 5 cm were formed using tilt-casting techniques.

The Cu₆₀Zr₃₀Ti₁₀ glassy metal piece has a glass transition temperature and a crystallization temperature of 683K and 728K, respectively. The Zr_{52.5}Cu_{17.9}Ni_{14.6}Al₁₀Ti₅ glassy metal piece has a glass transition temperature and a crystallization temperature of 681K and 743K, respectively. Each of the two glassy metal pieces of Cu₆₀Zr₃₀Ti₁₀ and Zr_{52.5}Cu_{17.9}Ni_{14.6}Al₁₀Ti₅ has a temperature difference between the glass transition temperature and the crystallization temperature of 45K and 62K, respectively.

The two glassy metal pieces of Cu₆₀Zr₃₀Ti₁₀ and Zr_{52.5}Cu_{17.9}Ni_{14.6}Al₁₀Ti₅ were cut into rods having a length of 3 mm, which were ground at bonding surfaces thereof using sandpaper so that the bonding surfaces have a roughness ranging from 1 to 3 μm. The two glassy metal rods were cleaned in an acetone solvent for 30 minutes using ultrasonic cleaning techniques. After cleaning, the two glassy metal rods were placed on a holder in an end-to-end contact manner, and a loading object was mounted on one of the two glassy metal rods so as to provide a pressure of about 12 MPa on the two glassy metal rods. The assembly was subsequently disposed in a quartz oven, which was operated under a vacuum not larger than 10⁻⁵ torr and a working temperature of 100° C., for 10 min so as to remove residue, such as water. After removal of residue, the working temperature was raised at a rate of 5° C./min up to 710° C., and was maintained at the working temperature for 1 hr, and an argon gas was introduced for the dissimilar bonding of the two glassy metal rods.

### Example 2

The bonding conditions of Example 2 were similar to those of Example 1, except that each of the two glassy metal pieces was Cu₆₀Zr₃₀Ti₁₀.

### Example 3

The bonding conditions of Example 3 were similar to those of Example 1, except that each of the two glassy metal pieces was Zr_{52.5}Cu_{17.9}Ni_{14.6}Al₁₀Ti₅.

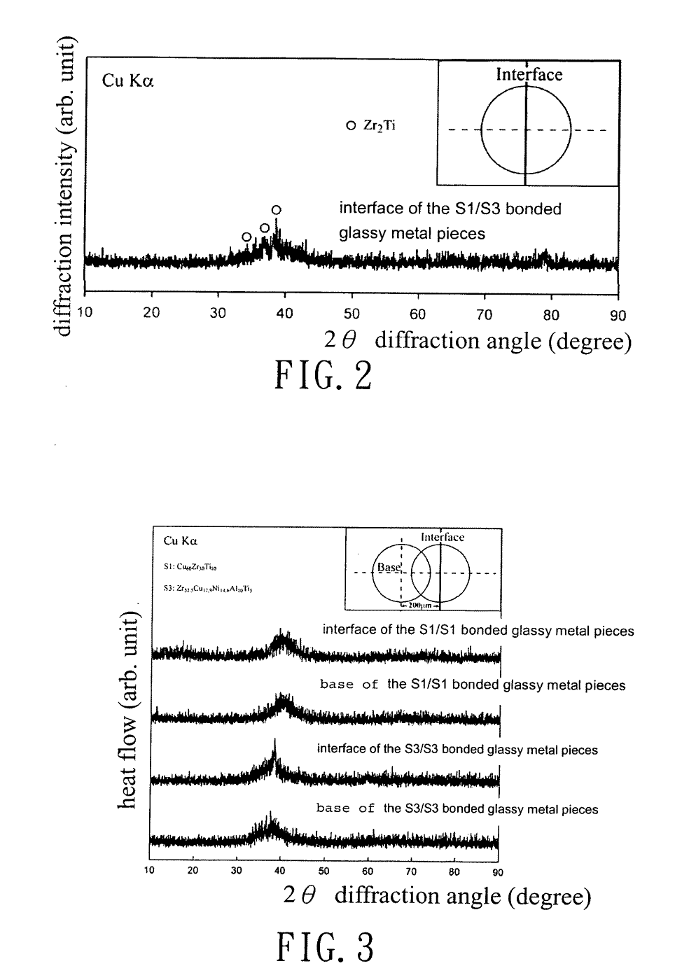

FIG. 2 is an X-ray diffraction graph at an interface showing a major amorphous structure diffuse peak including Zr₂Ti crystal peaks of the S1/S3 dissimilar bonded glassy metal pieces for Example 1. The results show that a trace amount of undesired Zr₂Ti crystals was formed (see FIG. 2) and an inter diffusion layer having a breadth ranging from 1 μm to 2 μm is formed at the interface of the dissimilar bonded glassy metal rods due to element inter diffusion each other, which resulted from the concentration difference of the two glassy metal rods having different compositions. Since the amount of Zr₂Ti crystals thus formed is extremely low, the interface of the bonded glassy metal rods can be considered as having a substantially amorphous structure.

FIG. 3 is an X-ray diffraction graph showing the fully amorphous structure diffuse peaks of the base (a portion away from the interface) and the interface of the S1/S1 and S3/S3 similar bonded glassy metal rods for Examples 2 and 3. The results show that no crystals exist at the interface of the bonded glassy metal rods for Examples 2 and 3.

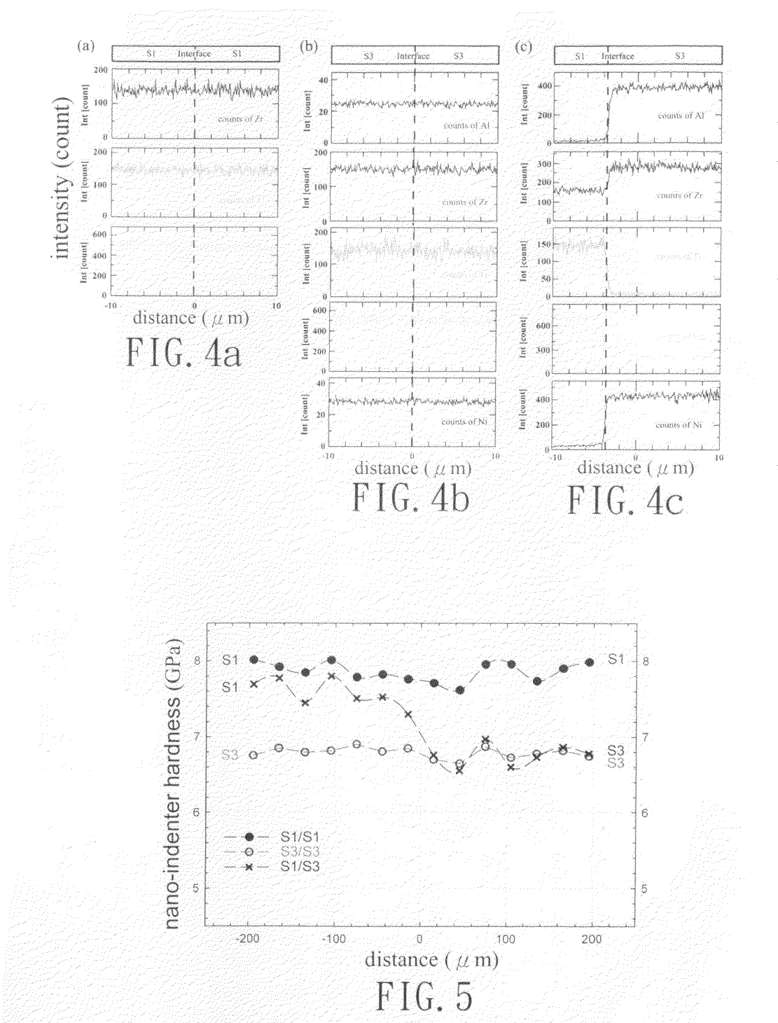

FIGS. 4a to 4c are electron probe microanalyzer plots showing a concentration distribution of each element of the bonded glassy metal rods from one end to the other end of the bonded glassy metal rods for Examples 1 to 3, respectively. The results of FIGS. 4a and 4b show that the concentration distribution of each element of Examples 2 and 3 is relatively uniform and that the interface of similar joint between the roughened contact surfaces of the two glassy metal rods disappears due to a spontaneous process of minimization of the surface free energy. FIG. 4c shows that a concentration gradient for the concentration distribution of each element of Example 1 occurs, which confirms the presence of the element diffusion for two different compositions of the dissimilar bonded glassy metal rods.

FIG. 5 is a plot showing nano-indenter hardness/distance relation, which was measured using nano indenter techniques. The zero in the coordinate in FIG. 5 represents the location of the interface of the bonded glassy metal rods. The results show that the hardness of the similar bonded glassy metal rods of Examples 2 and 3 is uniform from one end to the other end thereof, while the dissimilar bonded glassy metal rods of Example 1 has a smooth hardness-decreasing gradient region around the interface zone.

By disposing the glassy metal pieces in an environment heated to a working temperature within a common supercooled liquid region of the glassy metal pieces, the aforesaid drawbacks associated with the prior art can be eliminated.

With the invention thus explained, it is apparent that various modifications and variations can be made without departing from the spirit of the present invention. It is therefore intended that the invention be limited only as recited in the appended claims.

What is claimed is:

1. A method for bonding two glassy metal pieces, comprising:
(a) disposing the glassy metal pieces in an environment such that the surrounding of the glassy metal pieces is heated to a working temperature within a common supercooled liquid region of the glassy metal pieces; and
(b) pressing one of the glassy metal pieces against the other of the glassy metal pieces under an elevated pressure while maintaining the working temperature for a suitable period of time so as to subject the glassy metal pieces to undergo solid state diffusion at an interface therebetween.

2. The method of claim 1, wherein the elevated pressure in step (b) ranges from 12 MPa to 15 MPa.

3. The method of claim 1, wherein the glassy metal pieces in step (a) are disposed in a temperature-controllable oven.

4. The method of claim 1, wherein each of the glassy metal pieces is Zr—Cu based glassy metal.

5. The method of claim 4, wherein the Zr—Cu based glassy metal has a glass forming ability γₘ not less than 0.68.

6. The method of claim 5, wherein the Zr—Cu based glassy metal is Cu₆₀Zr₃₀Ti₁₀.

7. The method of claim 4, wherein the Zr—Cu based glassy metal has a glass forming ability γₘ not less than 0.74.

8. The method of claim 7, wherein the glassy metal is Zr_{52.5}Cu_{17.9}Ni_{14.6}Al₁₀Ti₅.

9. The method of claim 2, wherein the common supercooled liquid region ranges from 10K to 20K.

10. The method of claim 1, wherein the environment in step (a) is under a vacuum not larger than 10⁻⁵ torr.

11. The method of claim 1, wherein the environment in step (a) is an inert gas environment.
